(19) United States
(12) Patent Application Publication
(10) Pub. No.: US 2026/0241809 A1
(43) Pub. Date: Aug. 20, 2026

(54) FUEL CELL DEVICE

(71) Applicant: HONDA MOTOR CO., LTD., TOKYO (JP)

(72) Inventors: Kei YOSHIDA, WAKO-SHI (JP); Kohei KAKUTA, WAKO-SHI (JP); Atsushi SHIMIZU, WAKO-SHI (JP)

(21) Appl. No.: 19/541,995

(22) Filed: Feb. 17, 2026

(30) Foreign Application Priority Data
Feb. 18, 2025 (JP) 2025-024129

(51) Int. Cl. B60L 50/71; H01M 8/04082; H01M 8/241; H01M 8/2475; H01M 8/248; H01M 8/2483

(52) U.S. Cl. CPC B60L 50/71; H01M 8/04201; H01M 8/241; H01M 8/2475; H01M 8/248; H01M 8/2483

(57) ABSTRACT

A support plate unit of a fuel cell device includes: a hollow cross-sectional structure portion including an upper metal plate and a lower metal plate; and an attachment portion for attaching a fastening member that fastens an attachment target and the support plate unit to each other. The attachment portion is provided with a reinforcing portion extending in the up-down direction and sandwiched between the upper metal plate and the lower metal plate, a recess that is recessed toward the inside of the support plate unit is formed in a surface of the support plate unit that faces the opposite side to a fuel cell stack, and the recess is adjacent to the attachment portion.

### CROSS-REFERENCE TO RELATED APPLICATIONS

This application is based upon and claims the benefit of priority from Japanese Patent Application No. 2025-024129 filed on February 18, 2025, the contents of which are incorporated herein by reference.

### BACKGROUND OF THE INVENTION

### Field of Invention

The present disclosure relates to a fuel cell device.

### Description of the Related Art

In recent years, research and development has been conducted on fuel cell devices that contribute to energy efficiency in order to ensure that more people have access to affordable, reliable, sustainable and modern energy.

JP 2020-104598 A discloses a fuel cell device provided with a support plate unit that supports a fuel cell stack.

### SUMMARY OF THE INVENTION

There has been a demand for a more satisfactory fuel cell device.

The present disclosure has the object of solving the above-described problem.

An aspect of the present disclosure is characterized by a fuel cell device comprising a support plate unit configured to support a fuel cell stack, wherein the support plate unit includes: a hollow cross-sectional structure portion including an upper metal plate and a lower metal plate; and an attachment portion configured to attach a fastening member configured to fasten an attachment target and the support plate unit to each other, the attachment portion is provided with a reinforcing portion extending in an up-down direction and sandwiched between the upper metal plate and the lower metal plate, a recess that is recessed toward an inside of the support plate unit is formed in a surface of the support plate unit that faces an opposite side to the fuel cell stack, and the recess is adjacent to the attachment portion.

According to the present disclosure, a more satisfactory fuel cell device can be provided.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a front view of a fuel cell device according to an embodiment of the present disclosure;

FIG. 2 is an exploded perspective view of the fuel cell device;

FIG. 3 is a partially omitted cross-sectional view taken along line III-III of FIG. 1;

FIG. 4 is a partially omitted cross-sectional view taken along line IV-IV of FIG. 3; and

FIG. 5 is an explanatory diagram of a support plate unit according to a modification.

### DETAILED DESCRIPTION OF THE INVENTION

A support plate unit of a fuel cell device includes, for example, a hollow cross-sectional structure portion including an upper metal plate and a lower metal plate. Such a support plate unit can be made lighter than a support plate unit having a solid cross-sectional structure, but the rigidity thereof is likely to decrease. The support plate unit includes, for example, an attachment portion for attaching a fastening member that fastens an attachment target and the support plate unit to each other. In such a case, it is necessary to increase the rigidity of the attachment portion of the support plate unit. According to the present disclosure, it is possible to provide a fuel cell device in which the weight of the support plate unit can be reduced and the rigidity of the attachment portion can be increased.

A fuel cell device 10 according to an embodiment of the present disclosure will be described below with reference to the drawings. The fuel cell device 10 can be mounted on a vehicle (not shown) such as a fuel cell electric vehicle. The fuel cell device 10 may be mounted on a stationary power generation system or the like.

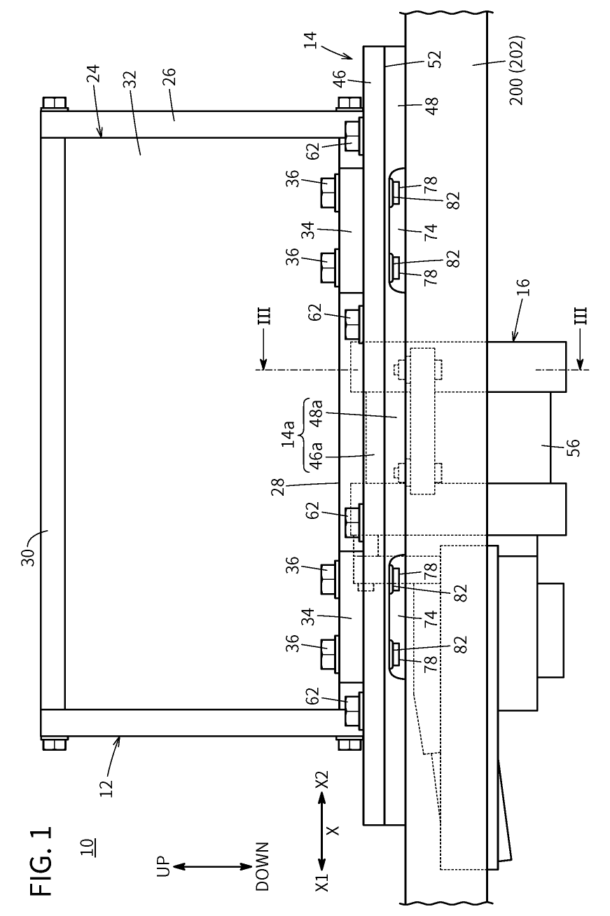

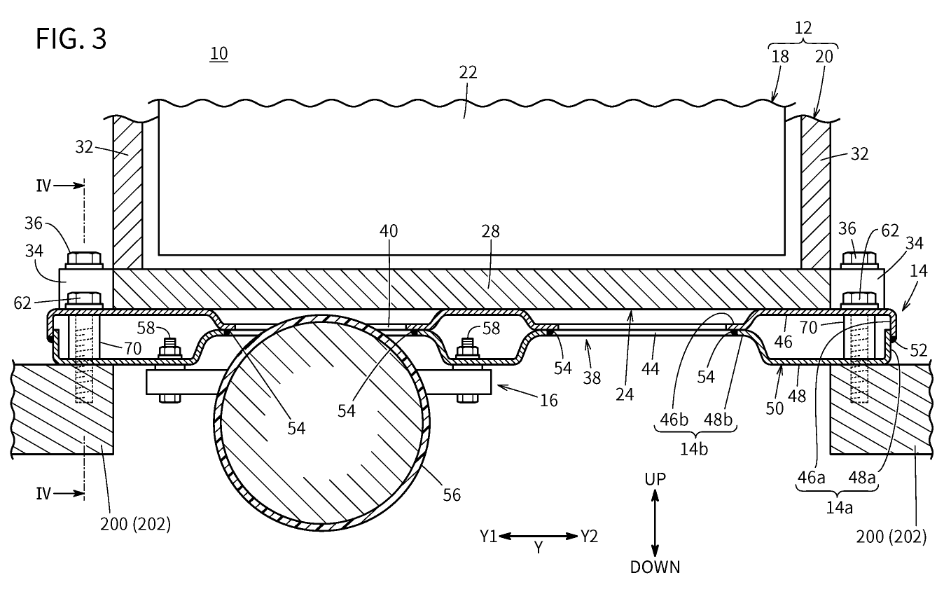

As shown in FIGS. 1 to 3, the fuel cell device 10 includes a fuel cell stack 12, a support plate unit (a support frame) 14, and an auxiliary member 16. As shown in FIG. 3, the fuel cell stack 12 includes a fuel cell body 18 and a stack case 20. The fuel cell body 18 is formed by stacking a plurality of power generation cells 22. In the present embodiment, the plurality of power generation cells 22 are stacked in an X direction. Note that, in the following description, a direction orthogonal to the X direction and the up-down direction may be referred to as a Y direction. The power generation cells 22 generate electric power by an electrochemical reaction between a fuel gas (for example, hydrogen gas) and an oxygen-containing gas (for example, air).

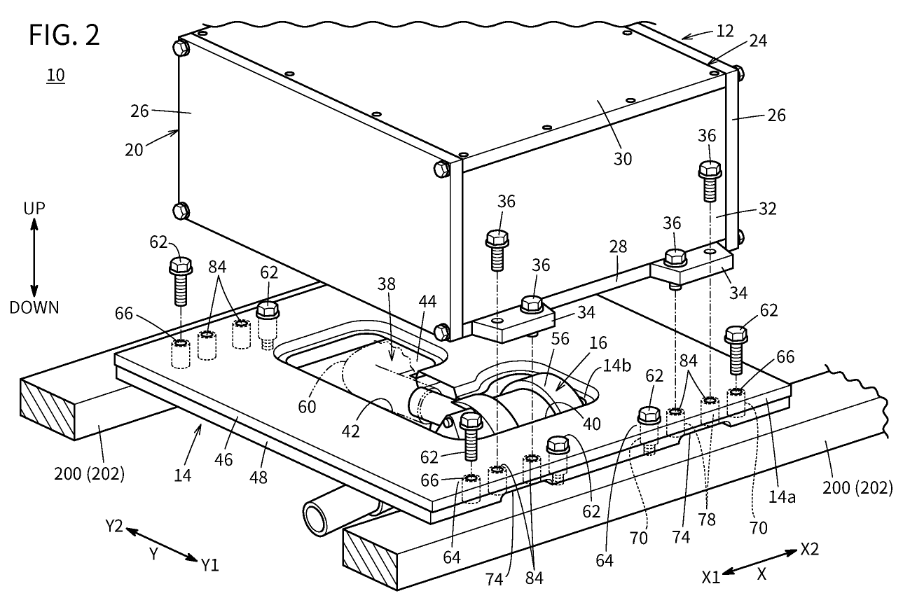

As shown in FIGS. 2 and 3, the stack case 20 accommodates the fuel cell body 18. The stack case 20 includes a peripheral wall case 24 and a pair of end plates 26. The peripheral wall case 24 is formed in a quadrangular tubular shape. The peripheral wall case 24 includes a lower plate 28, an upper plate 30, and a pair of side plates 32.

Two leg portions 34 are provided at each of both end portions of the lower plate 28 in the Y direction. The pair of leg portions 34 located at one end portion of the lower plate 28 in the Y direction (an end portion of the lower plate 28 in a Y1 direction) are separated from each other in the X direction. The pair of leg portions 34 located at the other end portion of the lower plate 28 in the Y direction (an end portion of the lower plate 28 in a Y2 direction) are separated from each other in the X direction. The leg portions 34 are each attached to the support plate unit 14 by a plurality of bolts 36. The structure for attaching the leg portions 34 to the support plate unit 14 will be described later. The number, position, size, and the like of the leg portions 34 can be set as appropriate.

As shown in FIGS. 1 to 3, the support plate unit 14 supports the fuel cell stack 12 and the auxiliary member 16. The fuel cell stack 12 is disposed above the support plate unit 14, and the auxiliary member 16 is disposed below the support plate unit 14. As a result, the fuel cell device 10 can be made compact. Further, the fuel cell stack 12 can be supported from below by the support plate unit 14.

As shown in FIG. 2, the support plate unit 14 is formed in an annular shape. A cutout portion 38 penetrating the support plate unit 14 in the up-down direction is formed in the central portion of the support plate unit 14. An outer peripheral edge portion 14a of the support plate unit 14 is formed in a quadrangular shape when viewed from above.

The cutout portion 38 includes a first hole portion 40, a second hole portion 42, and a third hole portion 44. The first hole portion 40 is located further in the Y1 direction than the central portion of the support plate unit 14 in the Y direction. The second hole portion 42 extends in the Y2 direction from the first hole portion 40. The third hole portion 44 is connected to an end of the second hole portion 42 in the Y2 direction. The width of the first hole portion 40 in the X direction is greater than the width of the second hole portion 42 in the X direction. The width of the third hole portion 44 in the X direction is smaller than the width of the first hole portion 40 in the X direction and greater than the width of the second hole portion 42 in the X direction.

As shown in FIG. 3, the support plate unit 14 includes a hollow cross-sectional structure portion 50 including an upper metal plate 46 and a lower metal plate 48. This makes it possible to increase the rigidity of the support plate unit 14 while reducing the weight of the support plate unit 14. Each of the upper metal plate 46 and the lower metal plate 48 is, for example, a steel plate, but is not limited thereto.

An outer peripheral edge portion 46a of the upper metal plate 46 and an outer peripheral edge portion 48a of the lower metal plate 48 overlap each other. The outer peripheral edge portion 46a of the upper metal plate 46 and the outer peripheral edge portion 48a of the lower metal plate 48 are joined to each other by a joint portion 52 (hereinafter, may be referred to as an "outer joint portion 52"). In other words, the outer joint portion 52 is provided on the outer peripheral edge portion 14a of the support plate unit 14. The outer joint portion 52 extends in a quadrangular shape along the outer peripheral edge portion 14a of the support plate unit 14. The outer joint portion 52 is not limited to the example in which it extends in a quadrangular shape, and may be intermittently provided on the outer peripheral edge portion 14a of the support plate unit 14.

An inner peripheral edge portion 46b of the upper metal plate 46 that forms the cutout portion 38 and an inner peripheral edge portion 48b of the lower metal plate 48 that forms the cutout portion 38 overlap each other. The inner peripheral edge portion 46b of the upper metal plate 46 and the inner peripheral edge portion 48b of the lower metal plate 48 are joined to each other by a joint portion 54 (hereinafter, may be referred to as an "inner joint portion 54"). In other words, the inner joint portion 54 is provided on an inner peripheral edge portion 14b of the support plate unit 14. The inner joint portion 54 extends along the outer periphery of the cutout portion 38. This makes it possible to increase the rigidity of the inner peripheral edge portion 14b of the support plate unit 14.

That is, the inner joint portion 54 is provided in the central portion of the support plate unit 14. In this case, the rigidity of the central portion of the support plate unit 14 can be increased by the inner joint portion 54. The inner joint portion 54 may be intermittently provided on the inner peripheral edge portion 14b of the support plate unit 14.

Each of the outer joint portion 52 and the inner joint portion 54 is, for example, a welded portion formed by welding together the upper metal plate 46 and the lower metal plate 48. Such a welded portion can be formed by, for example, laser welding, TIG welding, MIG welding, or the like. Each of the outer joint portion 52 and the inner joint portion 54 is not limited to a welded portion, and may be formed by, for example, friction stir welding.

As shown in FIGS. 2 and 3, a part of the auxiliary member 16 for driving the fuel cell stack 12 is disposed in the cutout portion 38. The auxiliary member 16 includes a coolant pump 56. Although other constituent elements may be included in the auxiliary member 16 apart from these constituent elements, description of such elements will be omitted herein. The coolant pump 56 serves to circulate a coolant through the fuel cell stack 12. As the coolant (cooling medium), for example, pure water can be used. The coolant may contain, for example, ethylene glycol.

A part of the coolant pump 56 is disposed in the first hole portion 40. This makes it possible to reduce the size of the fuel cell device 10 in the up-down direction. The coolant pump 56 is attached to the support plate unit 14 by a plurality of bolts 58 (see FIG. 3). The portion where the coolant pump 56 is attached (the position of each bolt 58) is adjacent to the inner joint portion 54. This makes it possible to stably support the coolant pump 56.

As shown in FIG. 2, a coolant supply pipe portion 60 for supplying, to the fuel cell stack 12, the coolant discharged from the coolant pump 56 is connected to the coolant pump 56. The coolant supply pipe portion 60 is disposed in the second hole portion 42 and the third hole portion 44. This facilitates the attachment of the components forming the auxiliary member 16, and the routing of the pipes. Further, the coolant pump 56 (the auxiliary member 16) and the fuel cell stack 12 can be connected to each other via the cutout portion 38 formed in the central portion of the support plate unit 14.

In the present embodiment, an example in which a part of the coolant pump 56 is disposed in the cutout portion 38 has been described, but a part of a component of the auxiliary member 16 other than the coolant pump 56 may be disposed in the cutout portion 38.

As shown in FIGS. 2 to 4, the support plate unit 14 includes a plurality of attachment portions 64 for attaching fastening members (for example, bolts) 62 that fasten an attachment target 200 and the support plate unit 14 to each other. The attachment target 200 is, for example, a vehicle body frame 202. The attachment target 200 is not limited to the vehicle body frame 202, and may be a frame of a stationary power generation system.

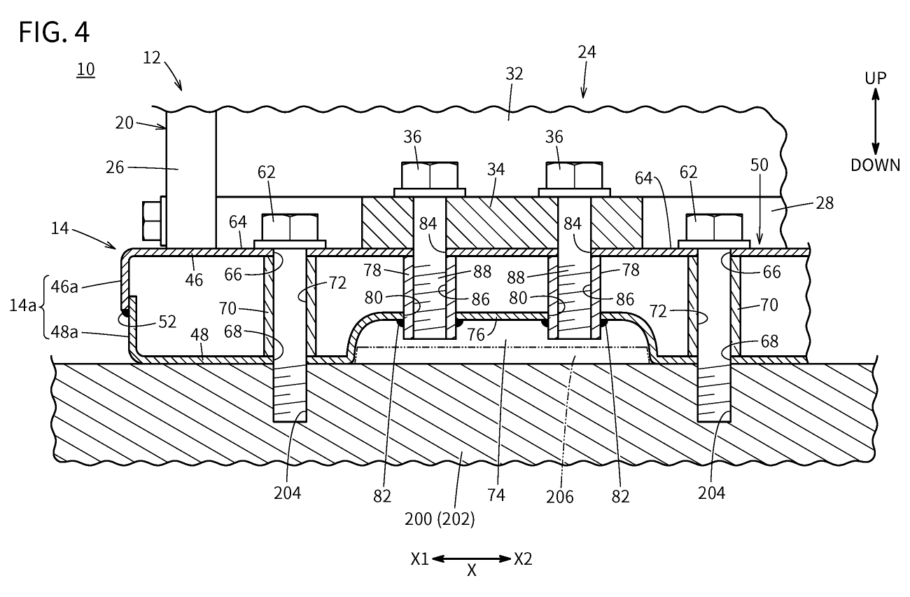

As shown in FIG. 4, the attachment portions 64 each include a first insertion hole 66 and a second insertion hole 68 for inserting the fastening member 62 therethrough. The first insertion hole 66 is formed in the upper metal plate 46. The second insertion hole 68 is formed in the lower metal plate 48. The attachment portions 64 are each provided with a reinforcing portion 70 that extends in the up-down direction and is sandwiched between the upper metal plate 46 and the lower metal plate 48. In this case, the rigidity of the attachment portion 64 can be increased by the reinforcing portion 70.

The reinforcing portion 70 is formed in a tubular shape (for example, a cylindrical shape). A hole 72 inside the reinforcing portion 70 communicates with the first insertion hole 66 and the second insertion hole 68. The reinforcing portion 70 is not limited to the example in which it has a tubular shape, and may have a C-shaped or U-shaped cross section.

The fastening members 62 each pass through the first insertion hole 66, the hole 72 inside the reinforcing portion 70, and the second insertion hole 68, and is screwed into a fastening hole (a screw hole) 204 formed in the attachment target 200. As a result, the support plate unit 14 and the attachment target 200 are fastened to each other, and the lower surface of the support plate unit 14 abuts on the upper surface of the attachment target 200.

A plurality of recesses 74 are formed in a surface of the support plate unit 14 that faces the opposite side to the fuel cell stack 12. That is, the recesses 74 are formed in the lower surface of the support plate unit 14. In other words, the recesses 74 are formed in the lower metal plate 48. Two recesses 74 are formed at the end portion of the support plate unit 14 in the Y1 direction, and two recesses 74 are formed at the end portion of the support plate unit 14 in the Y2 direction. The recesses 74 are recessed toward the inside of the support plate unit 14. The recesses 74 can be formed by press-forming a plate-shaped member.

The recesses 74 are each adjacent to the attachment portions 64. In other words, the attachment portions 64 are located on both sides of the recess 74 in the X direction. In this case, the rigidity of the attachment portions 64 can be increased by the recess 74.

A pair of support tube portions (collar members) 78 are provided in a wall portion 76 that forms each recess 74 (a bottom wall portion of the recess 74). The pair of support tube portions 78 are arranged side by side in the X direction. The support tube portions 78 are provided so as to extend over the upper metal plate 46 and the lower metal plate 48. The support tube portions 78 are disposed above the recess 74. As a result, the rigidity of the attachment portions 64 can be further increased by the support tube portions 78.

The support tube portions 78 penetrate the wall portion 76 forming the recess 74 and protrude into the recess 74. That is, through holes 80 for passing the support tube portions 78 therethrough are formed in the wall portion 76 forming the recess 74. Joint portions 82 at which the respective support tube portions 78 and the wall portion 76 forming the recess 74 are joined together are provided in the recess 74. As a result, since the support tube portions 78 can be joined to the support plate unit 14 from the recess 74 side (the outside of the support plate unit 14), the support tube portions 78 can be easily attached to the support plate unit 14.

The joint portions 82 each extend around the support tube portion 78. The joint portion 82 is, for example, a welded portion. Such a welded portion can be formed by, for example, laser welding, TIG welding, MIG welding, or the like. Ends (lower ends) of the support tube portions 78 in the protruding direction thereof are located in the recess 74. In other words, the ends of the support tube portions 78 in the protruding direction do not protrude to the outside of the recess 74. This can avoid interference between the support tube portions 78 and the attachment target 200.

The upper metal plate 46 includes hole portions 84 respectively communicating with the interiors of the support tube portions 78. Female threaded portions 86 are formed on the inner surfaces of the support tube portions 78. The bolts 36 for attaching the leg portions 34 of the fuel cell stack 12 to the support plate unit 14 are inserted into the support tube portions 78 through the hole portions 84. Male threaded portions 88 of the bolts 36 are screwed into the female threaded portions 86 of the support tube portions 78. As a result, the fuel cell stack 12 can be easily attached to the support plate unit 14. Further, the rigidity of the portion of the support plate unit 14 to which the fuel cell stack 12 is attached can be increased.

According to the present embodiment, since the support plate unit 14 includes the hollow cross-sectional structure portion 50, the weight of the support plate unit 14 can be reduced. Further, since the reinforcing portions 70 are provided in the attachment portions 64 of the support plate unit 14, the rigidity of the attachment portions 64 can be increased. Furthermore, since each recess 74 is provided at a position adjacent to the attachment portions 64, the rigidity of the attachment portions 64 can be further increased by the recess 74. In addition, since the recesses 74 are recessed toward the inside of the support plate unit 14 and do not protrude outward, the recesses 74 do not hinder the fastening of the attachment target 200 and the support plate unit 14 by the fastening members 62.

As shown in FIG. 4, in the fuel cell device 10, when the attachment target 200 and the support plate unit 14 are fastened by the fastening members 62, a protrusion 206 provided on the attachment target 200 may be fitted (inserted) into each recess 74. In this case, positioning between the support plate unit 14 and the attachment target 200 can be easily performed. Further, the fitting of the protrusions 206 into the recesses 74 can increase the fastening strength between the support plate unit 14 and the attachment target 200.

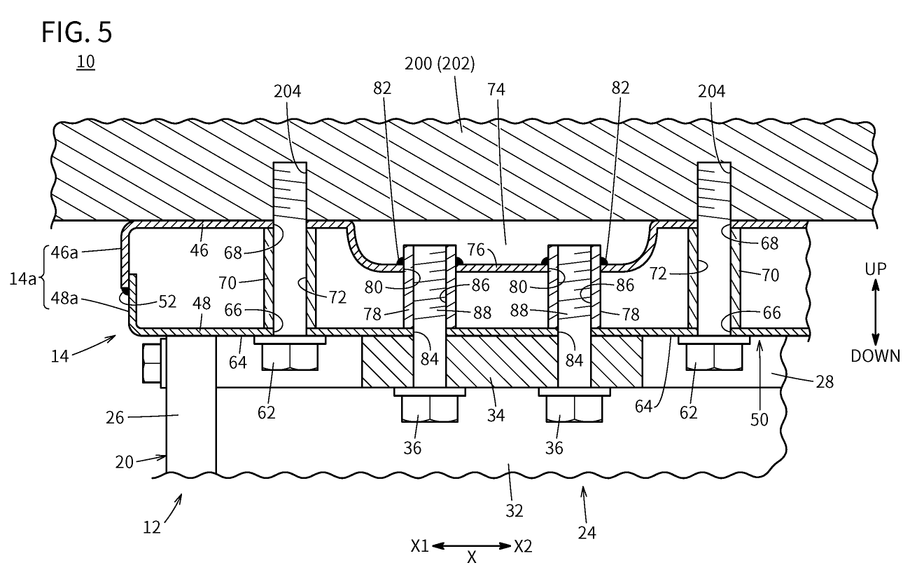

The fuel cell device 10 is not limited to having the above-described configuration. For example, as shown in FIG. 5, each recess 74 may be formed in the upper surface (the upper metal plate 46) of the support plate unit 14. In this case, the fuel cell stack 12 can be disposed below the support plate unit 14, and the attachment target 200 can be disposed above the support plate unit 14. Even in such a case, the above-described effects can be achieved.

The present embodiment is not limited to the example in which the support tube portions 78 are provided in the wall portion 76 forming the recess 74. The support tube portions 78 may be disposed in a portion of the support plate unit 14 different from the wall portion 76. In this case, the through holes 80 are not formed in the wall portion 76. The attachment target 200 is not limited to a mount member for installing the fuel cell device 10, and may be, for example, a component forming the auxiliary member 16.

The following supplementary notes are further disclosed in relation to the above-described embodiment.

### Supplementary Note 1

The fuel cell device (10) of the present disclosure includes the support plate unit (14) configured to support the fuel cell stack (12), wherein the support plate unit includes: the hollow cross-sectional structure portion (50) including the upper metal plate (46) and the lower metal plate (48); and the attachment portion (64) configured to attach the fastening member (62) configured to fasten the attachment target (200) and the support plate unit to each other, the attachment portion is provided with the reinforcing portion (70) extending in the up-down direction and sandwiched between the upper metal plate and the lower metal plate, the recess (74) that is recessed toward the inside of the support plate unit is formed in the surface of the support plate unit that faces the opposite side to the fuel cell stack, and the recess is adjacent to the attachment portion.

According to such a configuration, since the support plate unit includes the hollow cross-sectional structure portion, the weight of the support plate unit can be reduced. Further, since the reinforcing portion is provided in the attachment portion of the support plate unit, the rigidity of the attachment portion can be increased. Furthermore, since the recess is provided at a position adjacent to the attachment portion, the rigidity of the attachment portion can be further increased by the recess. In addition, since the recess is recessed toward the inside of the support plate unit and does not protrude outward, the recess does not hinder the fastening of the attachment target and the support plate unit by the fastening member.

### Supplementary Note 2

In the fuel cell device according to Supplementary Note 1, the fuel cell stack may be disposed above the support plate unit, and the recess may be formed in the lower surface of the support plate unit.

According to such a configuration, the fuel cell stack can be supported from below by the support plate unit.

### Supplementary Note 3

In the fuel cell device according to Supplementary Note 1, the recess may be adjacent to the attachment portion, the support plate unit may be provided with the support tube portion (78) extending over the upper metal plate and the lower metal plate, and the support tube portion may be disposed above the recess.

According to such a configuration, the rigidity of the attachment portion can be further increased by the support tube portion.

### Supplementary Note 4

In the fuel cell device according to Supplementary Note 3, the support tube portion may penetrate the wall portion (76) forming the recess and protrude into the recess, and the joint portion (82) at which the support tube portion and the wall portion forming the recess are joined to each other may be provided in the recess.

According to such a configuration, since the support tube portion can be joined to the support plate unit from the recess side (the outside of the support plate unit), the support tube portion can be easily attached to the support plate unit.

### Supplementary Note 5

In the fuel cell device according to Supplementary Note 4, the end of the support tube portion in the protruding direction thereof may be located in the recess.

According to such a configuration, it is possible to avoid interference between the support tube portion and the attachment target.

### Supplementary Note 6

In the fuel cell device according to any one of Supplementary Notes 3 to 5, the female threaded portion (86) may be formed on the inner surface of the support tube portion.

According to such a configuration, the fuel cell stack can be easily attached to the support plate unit by, for example, screwing the male threaded portion of the bolt for attaching the fuel cell stack, into the female threaded portion of the support tube portion. Further, the rigidity of the portion of the support plate unit to which the fuel cell stack is attached can be increased.

### Supplementary Note 7

In the fuel cell device according to any one of the Supplementary Notes 1 to 6, the inner joint portion (54) at which the upper metal plate and the lower metal plate are joined to each other may be provided in the central portion of the support plate unit.

According to such a configuration, the rigidity of the central portion of the support plate unit can be increased by the inner joint portion.

### Supplementary Note 8

In the fuel cell device according to Supplementary Note 7, the cutout portion (38) penetrating the support plate unit in the up-down direction may be formed in the central portion of the support plate unit, the inner joint portion may extend along the outer periphery of the cutout portion, and a part of the auxiliary member (16) configured to drive the fuel cell stack may be disposed in the cutout portion.

According to such a configuration, since a part of the auxiliary member is disposed in the cutout portion, it is possible to facilitate assembly of the components forming the auxiliary member and routing of the pipes. Further, the auxiliary member and the fuel cell stack can be connected to each other via the cutout portion.

Although the present disclosure has been described in detail, the present disclosure is not limited to the above-described individual embodiments. Various additions, replacements, modifications, partial deletions, and the like can be made to these embodiments without departing from the essence and gist of the present disclosure or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A fuel cell device comprising a support plate unit configured to support a fuel cell stack,
wherein the support plate unit includes:
a hollow cross-sectional structure portion including an upper metal plate and a lower metal plate; and
an attachment portion configured to attach a fastening member configured to fasten an attachment target and the support plate unit to each other,
the attachment portion is provided with a reinforcing portion extending in an up-down direction and sandwiched between the upper metal plate and the lower metal plate,
a recess that is recessed toward an inside of the support plate unit is formed in a surface of the support plate unit that faces an opposite side to the fuel cell stack, and
the recess is adjacent to the attachment portion.

2. The fuel cell device according to claim 1, wherein
the fuel cell stack is disposed above the support plate unit, and
the recess is formed in a lower surface of the support plate unit.

3. The fuel cell device according to claim 1, wherein
the recess is adjacent to the attachment portion,
the support plate unit is provided with a support tube portion extending over the upper metal plate and the lower metal plate, and
the support tube portion is disposed above the recess.

4. The fuel cell device according to claim 3, wherein
the support tube portion penetrates a wall portion forming the recess, and protrudes into the recess, and
a joint portion at which the support tube portion and the wall portion forming the recess are joined to each other is provided in the recess.

5. The fuel cell device according to claim 4, wherein
an end of the support tube portion in a protruding direction of the support tube portion is located in the recess.

6. The fuel cell device according to claim 3, wherein
a female threaded portion is formed on an inner surface of the support tube portion.

7. The fuel cell device according to claim 1, wherein
an inner joint portion at which the upper metal plate and the lower metal plate are joined to each other is provided in a central portion of the support plate unit.

8. The fuel cell device according to claim 7, wherein
a cutout portion penetrating the support plate unit in the up-down direction is formed in the central portion of the support plate unit,
the inner joint portion extends along an outer periphery of the cutout portion, and
a part of an auxiliary member configured to drive the fuel cell stack is disposed in the cutout portion.
